(19) United States
(12) Patent Application Publication
(10) Pub. No.: US 2015/0327158 A1
(43) Pub. Date: Nov. 12, 2015

(54) BASIC PROBE REQUEST

(71) Applicant: QUALCOMM Incorporated, San Diego, CA (US)

(72) Inventor: Maarten Menzo Wentink, Naarden (NL)

(21) Appl. No.: 14/710,368

(22) Filed: May 12, 2015

Related U.S. Application Data
(60) Provisional application No. 61/992,022, filed on May 12, 2014.

(51) Int. Cl. H04W 48/16; H04W 8/00; H04B 1/707

(52) U.S. Cl. CPC H04W 48/16; H04B 1/707; H04W 8/005; H04W 88/08

(57) ABSTRACT

A method of scanning for access points (APs) within wireless range of a station (STA) includes broadcasting a basic probe request having a frame body consisting of three or less information elements, receiving from each of a number of APs a basic probe response including a service set identification (SSID) of the corresponding AP, and selectively initiating a regular probing operation with a subset of the number of APs based, at least part, on the received SSIDs.

### CROSS-REFERENCE TO RELATED APPLICATION

This application claims priority to co-pending and commonly-owned U.S. Provisional Patent Application No. 61/992,022 entitled “BASIC PROBE REQUEST” filed May 12, 2014, the entirety of which is incorporated by reference herein.

### TECHNICAL FIELD

The example embodiments relate generally to wireless networks, and specifically to probe requests and probe responses in Wi-Fi networks.

### BACKGROUND OF RELATED ART

A wireless local area network (WLAN) may be formed by one or more access points (APs) that provide a wireless communication channel or link with a number of client devices or stations (STAs). Each AP, which may correspond to a Basic Service Set (BSS), periodically broadcasts beacon frames to enable any STAs within wireless range of the AP to establish and/or maintain a communication link with the WLAN. Once a STA is associated with the AP, the AP and the STA may exchange data frames. When the STA receives a data frame from the AP, the STA typically transmits an acknowledgment (ACK) frame back to the AP to inform the AP that the STA has received the data frame.

The STA may periodically transmit probe requests (e.g., during scanning operations) to determine if there are any APs within range of the STA. The probe request typically includes 150 Bytes of information, and is typically transmitted at the lowest basic transmission rate of 1 Mbps. Thus, the transmission of the probe request from the STA to the AP typically lasts approximately 1.5 ms.

Each AP that receives the probe request transmits a probe response to the STA. Per current IEEE 802.11 standards, each probe response is to contain those information elements (IEs) that were included within the probe request and which are supported by the AP. Thus, each probe response is to “mirror” the probe request (e.g., and therefore contains a payload of similar size to that of the probe request, depending on the capabilities of the AP). Thus, each probe response typically takes approximately 1.5 ms to transmit, at the lowest basic rate of 1 Mbps, to the STA. Multiple probe responses (from multiple APs) may be received in response to a single probe request.

For environments in which a large number of STAs and/or a large number of APs contend for limited medium access at the same time (e.g., for STAs and APs in a sports arena or shopping mall), the exchange of probe requests and probe responses between the various STAs and the various APs may significantly reduce the available bandwidth of the shared wireless medium. Thus, it would be desirable to reduce the medium's bandwidth consumed by the exchange of probe requests and probe responses.

### BRIEF DESCRIPTION OF THE DRAWINGS

The example embodiments are illustrated by way of example and are not intended to be limited by the figures of the accompanying drawings, where like reference numerals refer to corresponding parts throughout the drawing figures.

FIG. 1 shows a block diagram of a wireless system within which the example embodiments may be implemented.

FIG. 2 shows a block diagram of a wireless station (STA) in accordance with the example embodiments.

FIG. 3 shows a block diagram of a wireless access point (AP) in accordance with the example embodiments.

FIG. 4 shows a sequence diagram depicting a probing operation in accordance with the example embodiments.

FIG. 5 shows an example frame format for regular probe requests and regular probe responses in accordance with the example embodiments.

FIG. 6A shows a first basic probe request in accordance with the example embodiments.

FIG. 6B shows a second basic probe request in accordance with the example embodiments.

FIG. 6C shows a third basic probe request in accordance with the example embodiments.

FIG. 7 is a flow chart depicting an exchange of basic probe requests/responses and regular probe requests/responses in accordance with the example embodiments.

FIG. 8 is a flow chart depicting an example scanning operation in accordance with the example embodiments.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

As used herein, the term “regular probe request” may refer to a probe request that contains information (e.g., information elements (IEs)) typically transmitted according to current IEEE 802.11 standards, and the term “regular probe response” may refer to a probe response that mirrors information (e.g., IEs) contained in the regular probe request (e.g., as per current IEEE 802.11 standards). Further, as used herein, the term “basic probe request” may refer to a probe request that contains less information (e.g., fewer IEs) than regular probe requests, and the term “basic probe response” may refer to a probe response that mirrors information contained in the basic probe request (e.g., and thus contains less information (e.g., fewer IEs) than regular probe responses).

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

As mentioned above, regular probe requests associated with current IEEE 802.11 standards typically include 150 Bytes of information and, when transmitted at the lowest basic transmission rate of 1 Mbps, have a transmit duration of approximately 1.5 ms. More specifically, the regular probe request has a frame body that may include the information elements (IEs) listed below in Table 1:

TABLE 1

| IE number | IE description |
|---|---|
| 1 | Service Set Identifier (SSID) |
| 2 | Supported rates |
| 3 | Request information |
| 4 | Extended Supported Rates |
| 5 | Direct Sequence Spread Spectrum (DSSS) Parameter Set |
| 6 | Supported Operating Classes |
| 7 | High Throughput (HT) Capabilities |
| 8 | 20/40 Basic Service Set (BSS) Coexistence |
| 9 | Extended Capabilities |
| 10 | SSID List |
| 11 | Channel Usage |
| 12 | Interworking |
| 13 | Mesh ID |
| 14 | Multi-band |
| 15 | Directed Multi-Gigabit (DMG) Capabilities |
| 16 | Multiple MAC Sublayers |
| 17 | Very High Throughput (VHT) Capabilities |
| 18 | Vendor Specific |

When an AP receives a probe request, the AP responds by sending a probe response that mirrors the information provided in the probe request intersected with the capabilities supported by the AP. Thus, for example, when an AP receives a regular probe request containing a selected number N of the information elements listed above, the AP is to send a regular probe response including the same information elements that were included in the regular probe request (e.g., or at least the number of information elements that are supported by the AP).

In accordance with the example embodiments, the portion of the wireless medium's bandwidth consumed by the exchange of probe requests and probe responses between a STA and a number of APs may be decreased by dividing the conventional exchange of regular probe requests and regular probe responses into a two-step operation for which the exchanged probe request and probe response frames in the first step contain less information (and thus occupy the shared wireless medium for less time) than regular probe requests and probe responses. The second step, which may include the exchange of a regular probe request and a regular probe response, may be selectively performed with a subset (e.g., with a selected one or more) of the APs.

More specifically, the STA may first initiate an exchange of basic probe requests and basic probe responses to identify nearby APs, and may then initiate an exchange of a regular probe request and a regular probe response with a subset of the APs that transmitted basic probe responses to obtain information and/or parameters that enable the STA to select one of the APs for a subsequent association operation. The basic probe request contains less information (e.g., fewer IEs) than regular probe requests, and therefore the basic probe response is (per current IEEE 802.11 standards) to contain less information (e.g., fewer IEs) than regular probe responses. As a result, the exchange of basic probe requests and basic probe responses may occupy the shared wireless medium for less time than regular probe requests and regular probe responses, thereby increasing the available bandwidth of the shared wireless medium.

The subsequent exchange of regular probe requests and regular probe responses with the selected AP(s) may be based, at least in part, on whether the STA has previously been associated with the AP(s) or whether a user selects a particular one of the APs for association. More specifically, for at least some embodiments, after the initial exchange of the basic probe requests and basic probe responses, the STA may transmit a regular probe request only to AP(s) having an SSID that matches an SSID stored in the STA or that is selected by a user of the STA. The stored SSID may be the SSID of an AP with which the STA was previously associated, may be one of a number of SSIDs already stored in the STA, or may be an SSID selected by the user of the STA (e.g., selected from a list of detected SSIDs generated in response to a scanning operation of the STA).

In this manner, the STA may send regular probe requests only to a selected subset of the nearby APs (e.g., the APs having an SSID that matches one of the stored or user-selected SSIDs) rather than to all nearby APs, which may increase the available bandwidth of the shared wireless medium. More specifically, the subsequent exchange of regular probe requests and regular probe responses may occupy the medium for less time than conventional exchanges of probe requests and probe responses because, for example, the subsequent exchange of regular probe requests and regular probe responses is between the STA and a selected subset of the APs (e.g., rather than with all nearby APs).

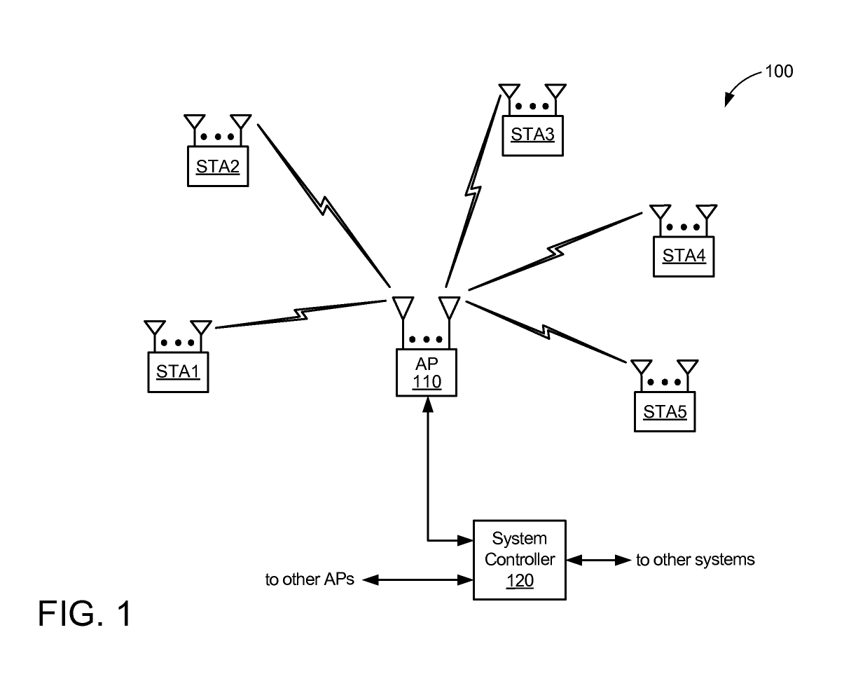

FIG. 1 is a block diagram of a wireless system 100 within which the example embodiments may be implemented. The wireless system 100 is shown to include five wireless stations STA1-STA5, a wireless access point (AP) 110, and a system controller 120. For example embodiments, the wireless system 100 may be a local area network (WLAN) that may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that the WLAN may be formed by any number of access points such as AP 110. The AP 110 is assigned a unique MAC address that is programmed therein by, for example, the manufacturer of the access point. Similarly, each of STA1-STA5 is also assigned a unique MAC address. For some embodiments, the wireless system 100 may correspond to a multiple-input multiple-output (MIMO) wireless network. Further, although the wireless system 100 is depicted in FIG. 1 as an infrastructure BSS, for other example embodiments, the wireless system 100 may be an IBSS, an ad-hoc network, or a peer-to-peer (P2P) network (e.g., operating according to the Wi-Fi Direct protocols).

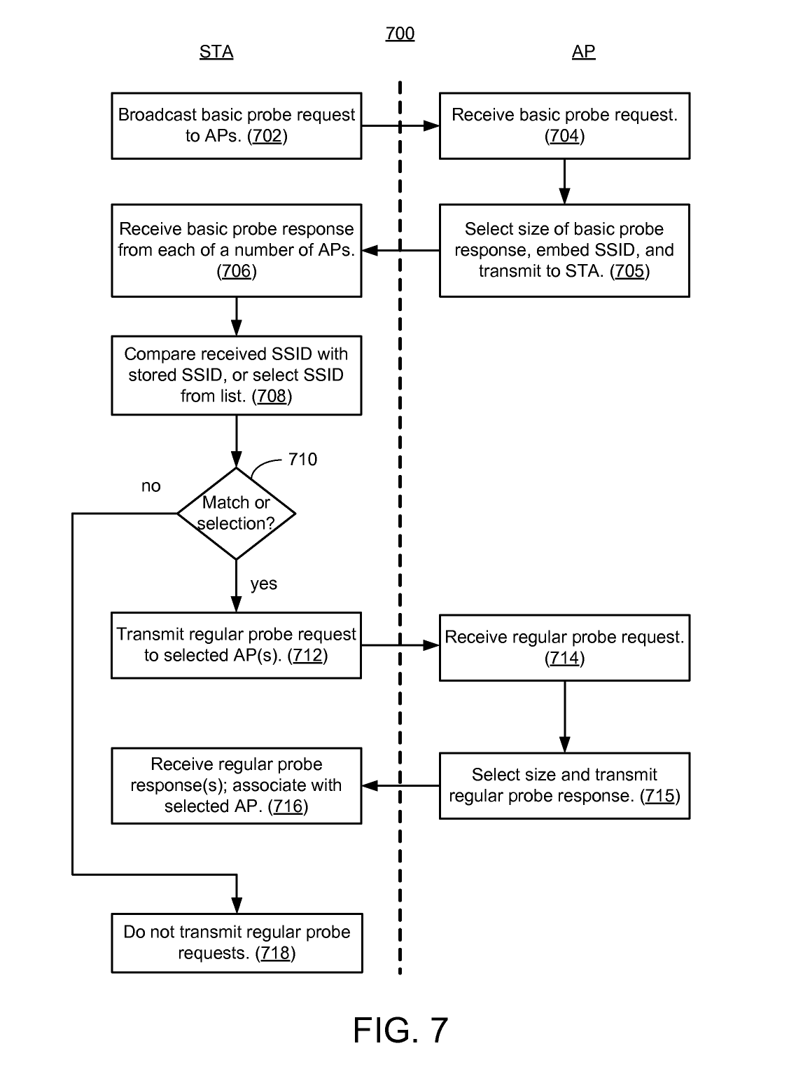

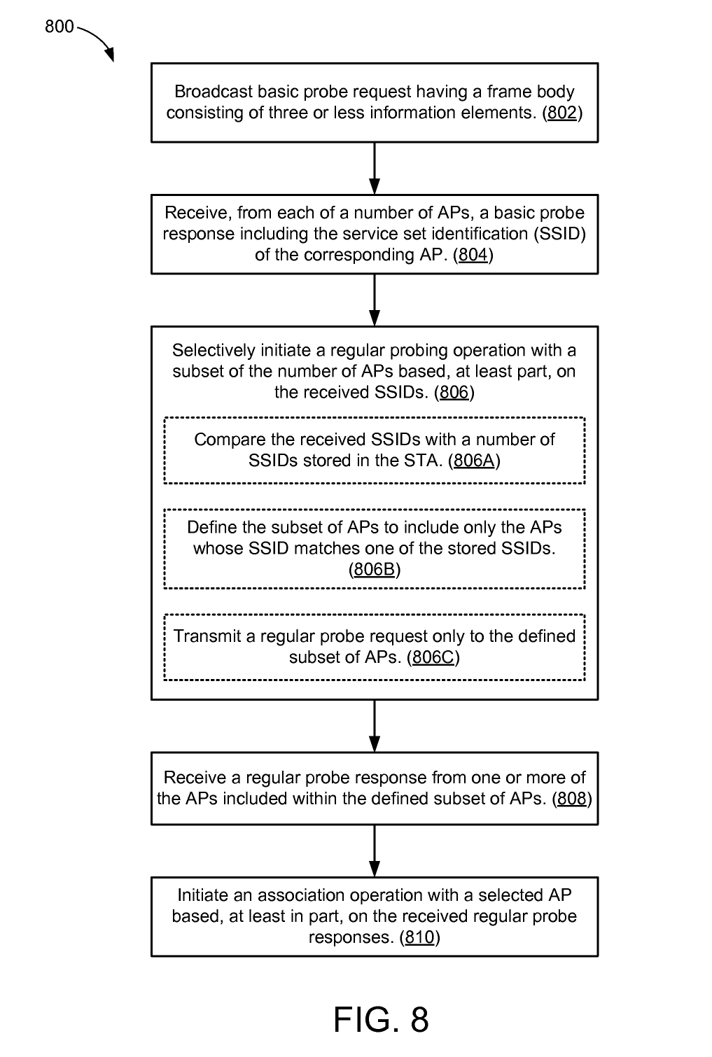

Each of stations STA1-STA5 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station STA may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 7-8.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 7-8.

For the stations STA1-STA5 and/or AP 110, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the stations STA1-STA5 and/or the AP 110 may be any technically feasible transceiver such as a ZigBee transceiver described by a specification from the ZigBee specification, a WiGig transceiver, and/or a HomePlug transceiver described a specification from the HomePlug Alliance.

The system controller 120 is coupled to AP 110, and may control various operations of AP 110. The system controller 120 may be coupled to any number of other APs (such as AP 110), and may coordinate operations of the various APs (e.g., that form an Extended Service Set (ESS) or a wide-area network (WAN)). The system controller 120 may also be coupled to other systems or networks, for example, to provide a backhaul connection between wireless system 100 and one or more other systems, networks, or devices.

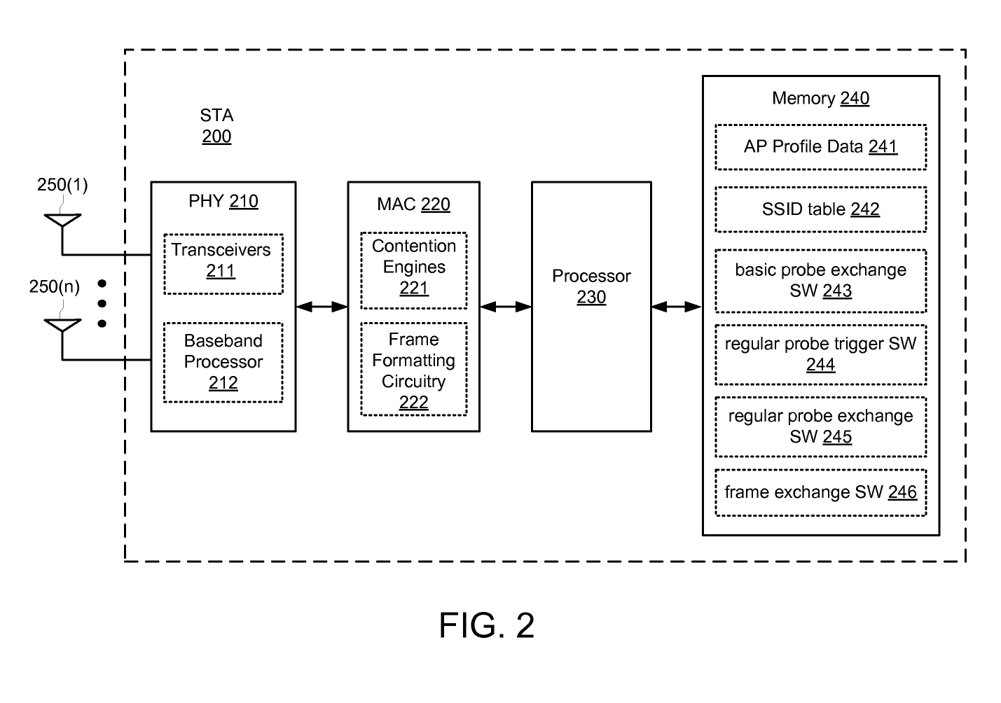

FIG. 2 shows an example STA 200 that may be one embodiment of the stations STA1-STA5 of FIG. 1. The STA 200 may include a PHY device 210 including at least a number of transceivers 211 and a baseband processor 212, may include a MAC device 220 including at least a number of contention engines 221 and frame formatting circuitry 222, may include a processor 230, may include a memory 240, and may include a number of antennas 250(1)-250(n). The transceivers 211 may be coupled to antennas 250(1)-250(n), either directly or through an antenna selection circuit (not shown for simplicity). The transceivers 211 may be used to transmit signals to and receive signals from AP 110 and/or other STAs (see also FIG. 1), and may be used to scan the surrounding environment to detect and identify nearby access points and/or other STAs (e.g., within wireless range of STA 200). Although not shown in FIG. 2 for simplicity, the transceivers 211 may include any number of transmit chains to process and transmit signals to other wireless devices via antennas 250(1)-250(n), and may include any number of receive chains to process signals received from antennas 250(1)-250(n). Thus, for example embodiments, the STA 200 may be configured for multiple-input, multiple-output (MIMO) operations. The MIMO operations may include single-user MIMO (SU-MIMO) operations and multi-user MIMO (MU-MIMO) operations.

The baseband processor 212 may be used to process signals received from processor 230 and/or memory 240 and to forward the processed signals to transceivers 211 for transmission via one or more of antennas 250(1)-250(n), and may be used to process signals received from one or more of antennas 250(1)-250(n) via transceivers 211 and to forward the processed signals to processor 230 and/or memory 240.

For purposes of discussion herein, MAC device 220 is shown in FIG. 2 as being coupled between PHY device 210 and processor 230. For actual embodiments, PHY device 210, MAC device 220, processor 230, and/or memory 240 may be connected together using one or more buses (not shown for simplicity).

The contention engines 221 may contend for access to one more shared wireless mediums, and may also store packets for transmission over the one more shared wireless mediums. The STA 200 may include one or more contention engines 221 for each of a plurality of different access categories. For other embodiments, the contention engines 221 may be separate from MAC device 220. For still other embodiments, the contention engines 221 may be implemented as one or more software modules (e.g., stored in memory 240 or stored in memory provided within MAC device 220) containing instructions that, when executed by processor 230, perform the functions of contention engines 221.

The frame formatting circuitry 222 may be used to create and/or format frames received from processor 230 and/or memory 240 (e.g., by adding MAC headers to PDUs provided by processor 230), and may be used to re-format frames received from PHY device 210 (e.g., by stripping MAC headers from frames received from PHY device 210).

Memory 240 may include an AP profile data store 241 that stores profile information for a plurality of APs. The profile information for a particular AP may include information including, for example, the AP's SSID, MAC address, channel information, RSSI values, goodput values, channel state information (CSI), supported data rates, connection history with STA 200, a trustworthiness value of the AP (e.g., indicating a level of confidence about the AP's location, etc.), and any other suitable information pertaining to or describing the operation of the AP.

For the example embodiment of FIG. 2, memory 240 also includes an SSID table 242 that stores a number of SSIDs for a number of APs. More specifically, the SSID table 242 may include a plurality of storage locations, each for storing an SSID and information about the corresponding AP. For some embodiments, the SSID table 242 may be pre-populated (e.g., loaded with predetermined SSIDs). For other embodiments, the SSID table 242 may include SSIDs corresponding to APs with which the STA 200 has been previously associated.

Memory 240 may also include a non-transitory computer-readable medium (e.g., one or more nonvolatile memory elements, such as EPROM, EEPROM, Flash memory, a hard drive, and so on) that may store the following software (SW) modules:
a basic probe exchange software module 243 to facilitate the creation and exchange of basic probe requests and basic probe responses between STA 200 and other wireless devices (e.g., as described for the STA-side of operations of FIG. 7 and/or the operations depicted in FIG. 8);
a regular probe trigger software module 244 to selectively trigger the transmission of regular probe requests to selected APs based, at least in part, on SSIDs of the selected APs (e.g., as described for the STA-side of operations of FIG. 7 and/or the operations depicted in FIG. 8);
a regular probe exchange software module 245 to selectively facilitate the creation and exchange of regular probe requests and regular probe responses based, at least in part, on the regular probe trigger software module 244 (e.g., as described for the STA-side of operations of FIG. 7 and/or the operations depicted in FIG. 8); and
a frame exchange software module 246 to facilitate the creation and exchange of any other suitable frames (e.g., data frames, action frames, and management frames) between STA 200 and other wireless devices (e.g., as described for the STA-side of operations of FIG. 7 and/or the operations depicted in FIG. 8).

Each software module includes instructions that, when executed by processor 230, cause STA 200 to perform the corresponding functions. The non-transitory computer-readable medium of memory 240 thus includes instructions for performing all or a portion of the STA-side operations depicted in FIG. 7 and/or the operations depicted in FIG. 8.

Processor 230, which is shown in the example of FIG. 2 as coupled to PHY device 210, to MAC device 220, and to memory 240, may be any suitable one or more processors capable of executing scripts or instructions of one or more software programs stored in STA 200 (e.g., within memory 240). For example, processor 230 may execute the basic probe exchange software module 243 to facilitate the creation and exchange of basic probe requests and basic probe responses between STA 200 and other wireless devices (e.g., APs). The basic probe exchange software module 243 may also be executed to select the size of the basic probe request and to select which information elements are to be included in the basic probe request.

Processor 230 may also execute the regular probe trigger software module 244 to selectively trigger the transmission of the regular probe requests to selected APs based, at least in part, on the SSIDs of the selected APs (e.g., which may indicate previous associations with the STA 200). Processor 230 may also execute the regular probe exchange software module 245 to selectively facilitate the creation and exchange of regular probe requests and regular probe responses based, at least in part, on the regular probe trigger software module 244. Processor 230 may also execute the frame exchange software module 246 to facilitate the creation and exchange of any other suitable frames (e.g., data frames, action frames, and management frames) between STA 200 and other wireless devices.

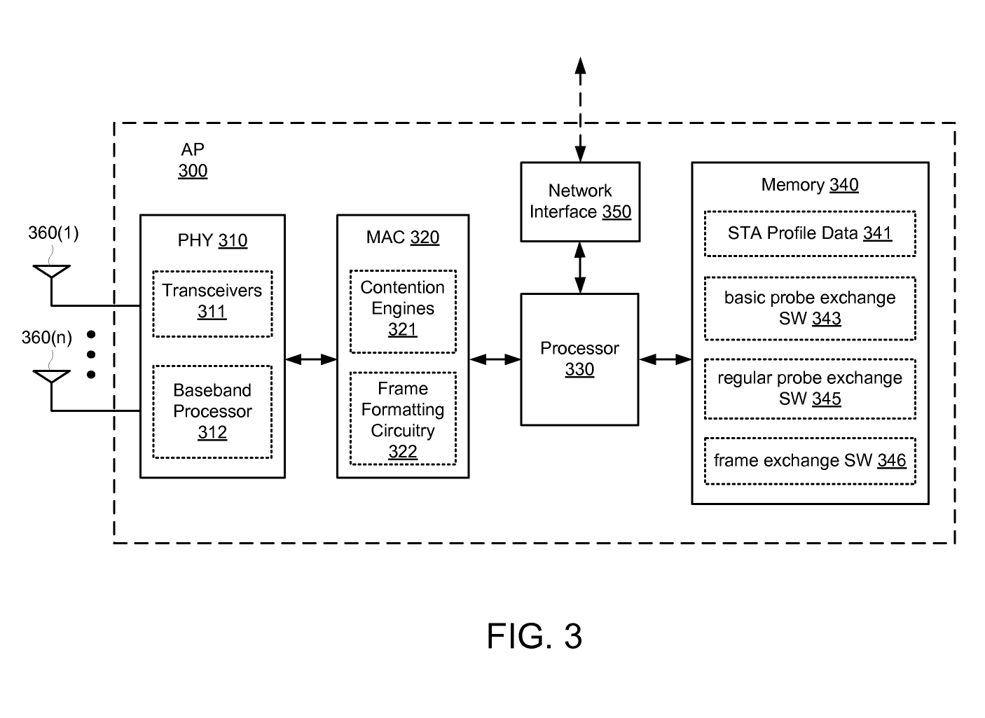

FIG. 3 shows an example AP 300 that may be one embodiment of the AP 110 of FIG. 1. AP 300 may include a PHY device 310 including at least a number of transceivers 311 and a baseband processor 312, may include a MAC device 320 including at least a number of contention engines 321 and frame formatting circuitry 322, may include a processor 330, may include a memory 340, may include a network interface 350, and may include a number of antennas 360(1)-360(n). The transceivers 311 may be coupled to antennas 360(1)-360(n), either directly or through an antenna selection circuit (not shown for simplicity). The transceivers 311 may be used to communicate wirelessly with one or more STAs, with one or more other APs, and/or with other suitable devices. Although not shown in FIG. 3 for simplicity, the transceivers 311 may include any number of transmit chains to process and transmit signals to other wireless devices via antennas 360(1)-360(n), and may include any number of receive chains to process signals received from antennas 360(1)-360(n). Thus, for example embodiments, the AP 300 may be configured for MIMO operations including, for example, SU-MIMO operations and MU-MIMO operations.

The baseband processor 312 may be used to process signals received from processor 330 and/or memory 340 and to forward the processed signals to transceivers 311 for transmission via one or more of antennas 360(1)-360(n), and may be used to process signals received from one or more of antennas 360(1)-360(n) via transceivers 311 and to forward the processed signals to processor 330 and/or memory 340.

The network interface 350 may be used to communicate with a WLAN server (e.g., the system controller 120 of FIG. 1) either directly or via one or more intervening networks and to transmit signals.

Processor 330, which is coupled to PHY device 310, to MAC device 320, to memory 340, and to network interface 350, may be any suitable one or more processors capable of executing scripts or instructions of one or more software programs stored in AP 300 (e.g., within memory 340). For purposes of discussion herein, MAC device 320 is shown in FIG. 3 as being coupled between PHY device 310 and processor 330. For actual embodiments, PHY device 310, MAC device 320, processor 330, memory 340, and/or network interface 350 may be connected together using one or more buses (not shown for simplicity).

The contention engines 321 may contend for access to the shared wireless medium, and may also store packets for transmission over the shared wireless medium. For some embodiments, AP 300 may include one or more contention engines 321 for each of a plurality of different access categories. For other embodiments, the contention engines 321 may be separate from MAC device 320. For still other embodiments, the contention engines 321 may be implemented as one or more software modules (e.g., stored in memory 340 or within memory provided within MAC device 320) containing instructions that, when executed by processor 330, perform the functions of contention engines 321.

The frame formatting circuitry 322 may be used to create and/or format frames received from processor 330 and/or memory 340 (e.g., by adding MAC headers to PDUs provided by processor 330), and may be used to re-format frames received from PHY device 310 (e.g., by stripping MAC headers from frames received from PHY device 310).

Memory 340 may include a STA profile data store 341 that stores profile information for a plurality of STAs. The profile information for a particular STA may include information including, for example, its MAC address, supported data rates, connection history with AP 300, and any other suitable information pertaining to or describing the operation of the STA.

Memory 340 may also include a non-transitory computer-readable medium (e.g., one or more nonvolatile memory elements, such as EPROM, EEPROM, Flash memory, a hard drive, and so on) that may store the following software (SW) modules:
a basic probe exchange software module 343 to facilitate the creation and exchange of basic probe requests and basic probe responses between AP 300 and other wireless devices (e.g., as described for the AP-side of operations of FIG. 7 and/or the operations depicted in FIG. 8);
a regular probe exchange software module 345 to facilitate the creation and exchange of regular probe requests and regular probe responses between AP 300 and other wireless devices (e.g., as described for the AP-side of operations of FIG. 7 and/or the operations depicted in FIG. 8); and
a frame exchange software module 346 to facilitate the creation and exchange of any other suitable frames (e.g., data frames, action frames, and management frames) between AP 300 and other wireless devices (e.g., as described for the AP-side of operations of FIG. 7 and/or the operations depicted in FIG. 8).
   Each software module includes instructions that, when executed by processor 330, cause AP 300 to perform the corresponding functions. The non-transitory computer-readable medium of memory 340 thus includes instructions for performing all or a portion of the AP-side operations depicted in FIG. 7 and/or the operations depicted in FIG. 8.

Processor 330, which is shown in the example of FIG. 3 as coupled to transceivers 311 of PHY device 310 via MAC device 320, to memory 340, and to network interface 350, may be any suitable one or more processors capable of executing scripts or instructions of one or more software programs stored in AP 300 (e.g., within memory 340). For example, processor 330 may execute the basic probe exchange software module 343 to facilitate the creation and exchange of basic probe requests and basic probe responses between AP 300 and other wireless devices (e.g., STAs). Processor 330 may also execute the regular probe exchange software module 345 to facilitate the creation and exchange of regular probe requests and regular probe responses between AP 300 and other wireless devices (e.g., STAs). Processor 330 may also execute the frame exchange software module 346 to facilitate the creation and exchange of any other suitable frames (e.g., data frames, action frames, and management frames) between AP 300 and other wireless devices.

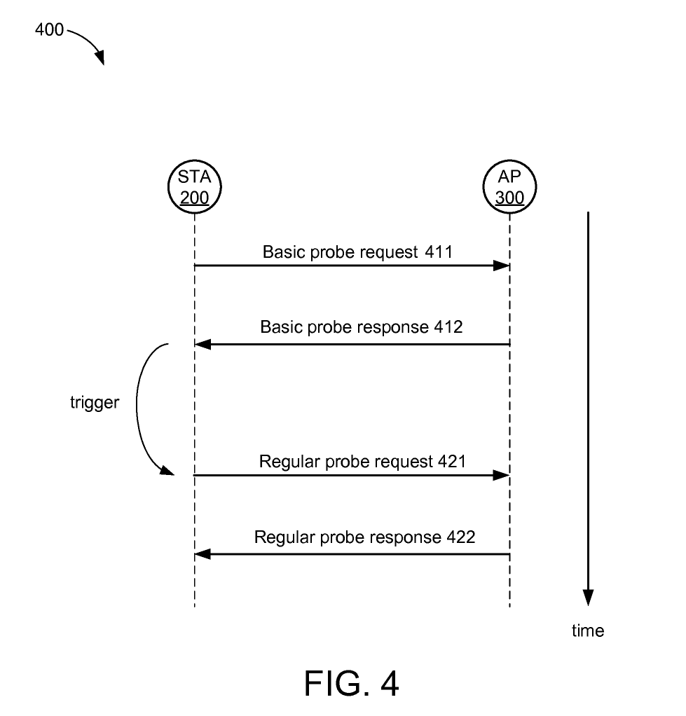

FIG. 4 depicts a probing operation 400 in accordance with example embodiments. The probing operation 400 of FIG. 4 is performed between STA 200 and AP 300. The STA 200 may be one embodiment of one or more of stations STA1-STA5 of FIG. 1, and the AP 300 may be one embodiment of the AP 110 of FIG. 1. Further, although the probing operation 400 is depicted in FIG. 4 as involving one STA 200 and one AP 300, for actual embodiments, the STA 200 may probe or scan for any suitable number of APs (such as AP 300), and the AP 300 may be probed or scanned by any number of STAs (such as STA 200).

To identify any APs within wireless range of the STA 200, the STA 200 may first broadcast a number of basic probe requests 411. The basic probe request 411 contains a subset of the information elements included within regular probe requests, for example, to minimize overhead on the wireless medium associated with identifying nearby APs. More specifically, the basic probe request 411 contains only information necessary to cause APs within wireless range to acknowledge their presence to STA 200.

In response to receiving the basic probe request 411, the AP 300 transmits a basic probe response 412 to the STA 200. The basic probe response 412 mirrors the size and content of the received basic probe request 411, and is therefore smaller (and takes less time to transmit) than regular probe responses. The basic probe response 412 includes at least the SSID of the AP 300.

The STA 200 may selectively transmit a regular probe request 421 to the AP 300 based, at least in part, on the received SSID. As mentioned above, the regular probe request 421 may indicate various capabilities and/or parameters of the STA 200, and may therefore include additional information not contained in the basic probe request 411 (e.g., an additional number of the IEs 1-18 listed above in Table 1). More specifically, the STA 200 may receive the basic probe response 412, may extract the SSID included in the basic probe response 412, and may compare the received SSID with SSIDs stored in STA 200 (e.g., in SSID table 242). If there is a match, then the STA 200 may transmit regular probe request 421 to the AP 300. As an alternative or an addition, the STA 200 may allow a user to select an SSID from a list of SSIDs, and thereafter send regular probe request 421 to the AP identified by the user. In response to receiving the regular probe request 421, the AP 300 may send a regular probe response 422 to the STA 200. Thereafter, the STA 200 may use information contained in the regular probe response 422 to initiate an association operation with the AP 300 (e.g., to establish a wireless link or channel with the AP 300).

If the received SSID does not match any of the stored or listed SSIDs (or if the user does not select an SSID from one of the received basic probe responses), then the STA 200 may not transmit regular probe request 421 to that AP, and therefore does not consume any more of the bandwidth of the shared wireless medium.

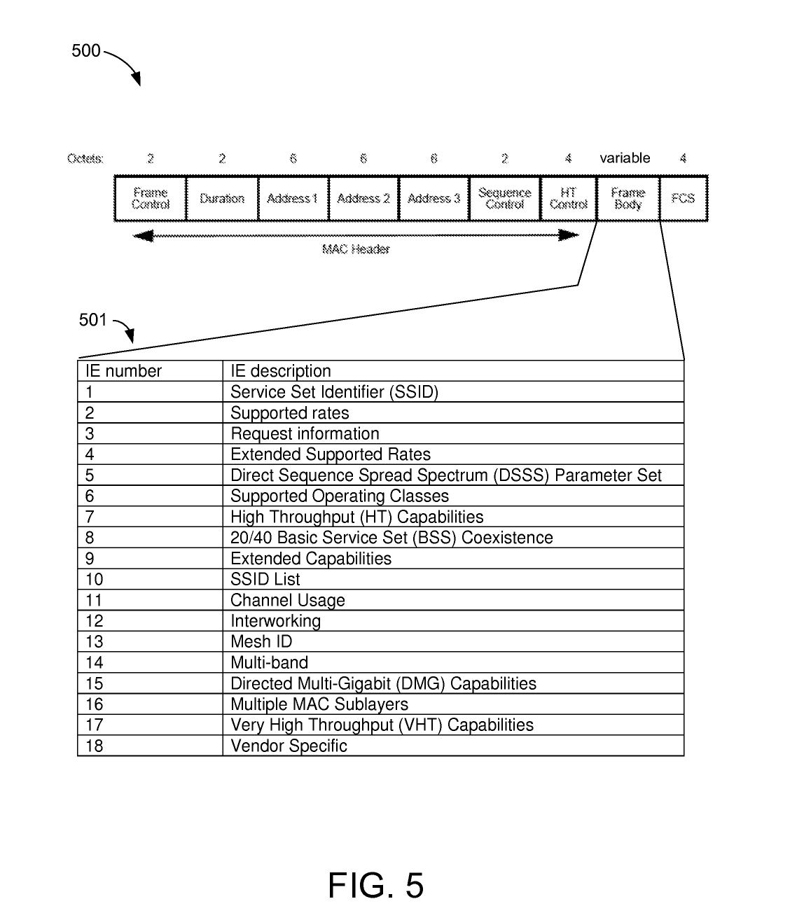

FIG. 5 shows an example frame format for a management frame 500 according to the IEEE 802.11ac standards. The management frame 500 may be used as the regular probe request 421 and/or the regular probe response 422 described above with respect to FIG. 4. Thus, the frame 500 may also be referred to herein as the “regular probe request frame 500.” The frame 500 includes a 32-byte MAC header and a variable-length frame body. The MAC header includes a 2-byte frame control field, a 2-byte frame duration field, three 6-byte address fields (Address1-Address3), a 2-byte sequence control field, a 4-byte high-throughput (HT) field, and a 4 byte frame control sequence (FCS) field. When frame 500 is used for regular probe request 421, the receiver address (RA) may be stored in the Address1 field, the transmitter address (TA) may be stored in the Address2 field, and the BSSID may be stored in the Address3 field. For the example of FIG. 5, the frame body of frame 500 is shown to include 18 information elements 501.

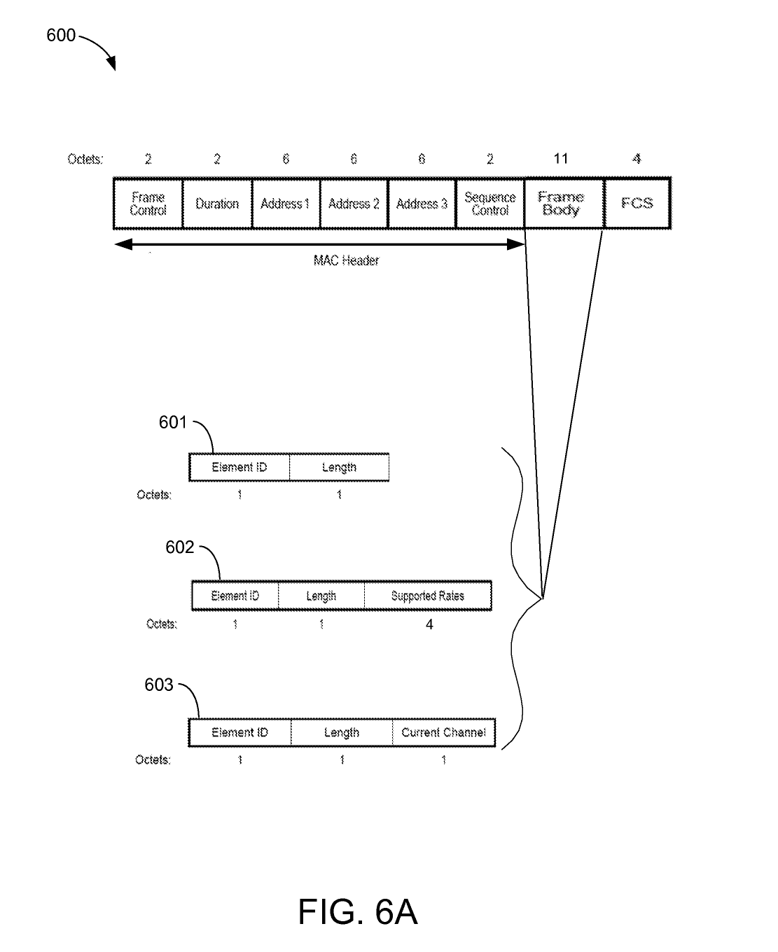

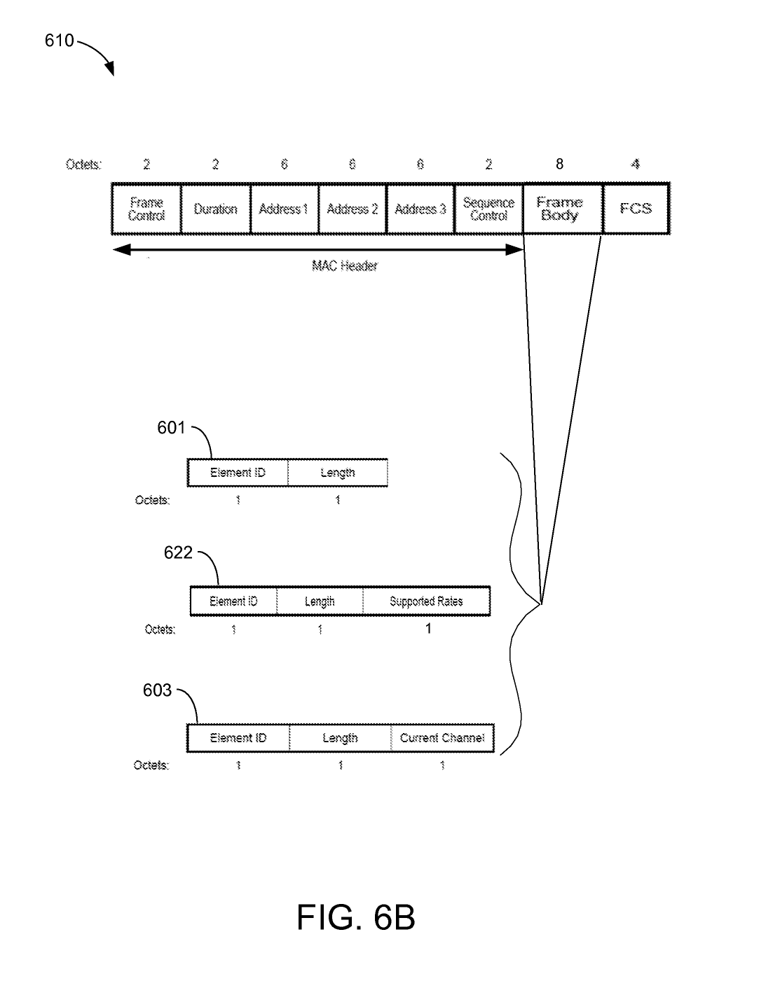

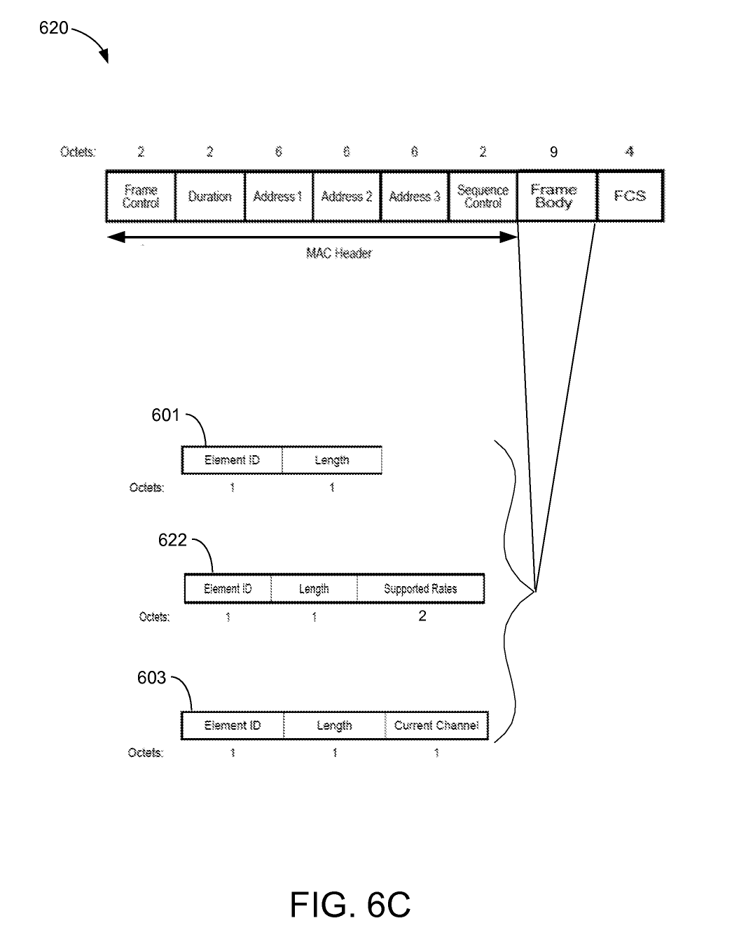

Referring again to FIG. 4, in accordance with example embodiments, the frame body of basic probe request 411 contains only a small subset of the information elements typically included in the regular probe request 421. For example, FIG. 6A shows a basic probe request 600 that may be a first embodiment of the basic probe request 411 of FIG. 4. The basic probe request 600 includes a 28-byte MAC header and an 11-byte frame body. The 11-byte frame body includes only three information elements: a 2-byte SSID information element 601, a 6-byte supported rates information element 602, and a 3-byte DSSS parameter set information element 603. The 28-byte MAC header includes a 2-byte frame control field, a 2-byte frame duration field, three 6-byte address fields (Address1-Address3), a 2-byte sequence control field, and a 4-byte frame control sequence (FCS) field. When basic probe request 600 is broadcast (e.g., by STA 200), the receiver address (RA) may be stored in the Address1 field, the transmitter address (TA) may be stored in the Address2 field, and the BSSID may be stored in the Address3 field. Note that in contrast to the regular probe request frame 500 of FIG. 5, the basic probe request 600 of FIG. 6A may not include the 4-byte HT field, thereby reducing the size of the MAC header of basic probe request 600 by 4 bytes (as compared with the MAC header of frame 500).

The sizes of the MAC header and information elements 601-603 of basic probe request 600 are summarized below in Table 2:

TABLE 2

| | | | |
|---|---|---|---|
| MAC header | 28 | Bytes | fc/dur/ra/ta/bssid/sc/fcs |
| SSID | 2 | Bytes | Broadcast SSID |
| Supported Rates | 6 | Bytes | 1, 2, 5.5, 11 |
| DS Parameter Set | 3 | Bytes | channel |
| total | 39 | Bytes | |
| Tx time at 1 Mbps | 504 | us | |
| Tx time at 1 Mbps SP | 432 | us | |

Thus, the basic probe request 600 shown in FIG. 6A and summarized in Table 2 includes a total of 39 bytes: a MAC header containing 28 bytes, an SSID information element 601 containing 2 bytes, a supported rates information element 602 containing 6 bytes, and a DSSS parameter set information element 603 containing 3 bytes. Thus, the basic probe request 600 contains less IEs (e.g., only the SSID, supported rates, and DSSS parameter set IEs) than regular probe requests (e.g., using frame 500 of FIG. 5), and is therefore smaller than regular probe requests. At the basic transmission rate of 1 Mbps, the basic probe request 600 takes approximately 504 us to transmit, which is approximately one-third of the transmit duration of a regular probe request. In this and other examples, the inclusion of a DSSS parameter set IE (sometimes also referred to as DS parameter set IE) is optional.

For another embodiment, the basic probe request may indicate support for only one transmission rate (e.g., 1 Mbps), which may eliminate 3 bytes of the supported rates IE. For example, FIG. 6B shows a basic probe request 610 that may be a second embodiment of the basic probe request 411 of FIG. 4. The basic probe request 610 includes a 28-byte MAC header and an 8-byte frame body. The 8-byte frame body includes only three information elements: the SSID information element 601, a supported rates information element 612, and the DSSS parameter set information element 603. The basic probe request 610 is similar to the basic probe request 600, except that the supported rates information element 612 of basic probe request 610 contains only 3 bytes (e.g., compared with the 6-byte supported rates information element 602 of basic probe request 600).

The sizes of the MAC header and information elements 601, 612, and 603 of basic probe request 610 are summarized below in Table 3:

TABLE 3

| | | | |
|---|---|---|---|
| MAC header | 28 | Bytes | fc/dur/ra/ta/bssid/sc/fcs |
| SSID | 2 | Bytes | Broadcast SSID |
| Supported Rates | 3 | Bytes | 1 |
| DS Parameter Set | 3 | Bytes | channel |
| total | 36 | Bytes | |
| Tx time at 1 Mbps | 480 | us | |
| Tx time at 1 Mbps SP | 408 | us | |

Thus, the basic probe request 610 shown in FIG. 6B and summarized in Table 3 includes a total of 36 bytes: a MAC header containing 28 bytes, SSID information element 601 containing 2 bytes, supported rates information element 612 containing 3 bytes, and DSSS parameter set information element 603 containing 3 bytes. At the basic transmission rate of 1 Mbps, the basic probe request 610 takes approximately 480 us to transmit, which is less than one-third of the transmit duration of a regular probe request.

The supported rates information element used in basic probe requests of the example embodiments may indicate the supported rates in units of 500 kbps. Typically, the supported rates information element indicates whether the STA 200 supports IEEE 802.11b rates of 1 Mbps, 2 Mbps, 5.5 Mbps, and 11 Mbps (encoded as values 2, 4, 11, and 22). For some embodiments, the STA 200 may include a non-standard rate (e.g., an encoded “pseudo-rate” not defined by the IEEE 802.11 standards) in the supported rates information element contained in basic probe requests. In accordance with the example embodiments, the “pseudo-rate” may indicate that the STA 200 supports more capabilities than those indicated in the basic probe request. For example, an encoded pseudo-rate of 127 in the supported rates information element may indicate that VHT is supported, an encoded pseudo-rate of 126 in the supported rates information element may indicate that HT is supported, and so on. If an AP such as AP 300 recognizes such non-standard rates in the supported rates information element contained in example embodiments of the basic probe request, the AP may respond with a regular probe response that contains all related capabilities (e.g., as opposed to responding with the basic probe response).

For example, FIG. 6C shows a basic probe request 620 that may be a third embodiment of the basic probe request 411 of FIG. 4. The basic probe request 620 is similar to the basic probe request 610 of FIG. 6B, except the basic probe request 620 includes a 4-byte supported rates information element 622 that includes a 2-byte supported rates field. The 2-byte supported rates field may store a non-standard rate (e.g., the encoded “pseudo-rate” not defined by the IEEE 802.11 standards) to indicate additional data rates supported by the STA 200. The frame body of basic probe request 620 contains 9 bytes, and thus the basic probe request 620 contains a total of 37 bytes.

The sizes of the MAC header and information elements 601, 622, and 603 of basic probe request 620 are summarized below in Table 4, which also depicts an example non-standard rate (e.g., a pseudo rate) of 126 that, for at least some embodiments, may indicate that STA 200 supports HT capabilities:

TABLE 4

| | | | |
|---|---|---|---|
| MAC header | 28 | Bytes | fc/dur/ra/ta/bssid/sc/fcs |
| SSID | 2 | Bytes | Broadcast SSID |
| Supported Rates | 4 | Bytes | 1, ‘126’ |
| DS Parameter Set | 3 | Bytes | channel |
| total | 37 | Bytes | |
| Tx time at 1 Mbps | 488 | us | |
| Tx time at 1 Mbps SP | 416 | us | |

FIG. 7 shows an example operation 700 between STA 200 and AP 300 in accordance with example embodiments. First, the STA 200 transmits a basic probe request to the AP 300 (702). The AP 300 receives the basic probe request (704). The AP 300 may select a size of a basic probe response (e.g., to mirror the basic probe request), and then transmit the basic probe response to the STA 200 (705). For some embodiments, the AP 300 may automatically mirror the received basic probe request when forming the basic probe response.

The STA 200 receives the basic probe response (706). The STA 200 may compare an SSID contained in the basic probe response from AP 300 (as well as SSIDs contained in basic probe responses received from other APs) with SSIDs stored in the STA 200 (e.g., the stored SSIDs may correspond to APs with which the STA 200 was previously associated), or the user may select the SSID from a list of SSIDs corresponding to received probe responses (708). If there is a match with SSIDs stored in the STA 200, as tested at 710, then the STA 200 may transmit a regular probe request to the AP corresponding to the matching SSID (712). Because the STA 200 may not transmit regular probe requests to other APs (e.g., APs not included in a selected subset of the APs identified at 705), the initial identification of nearby APs using basic probe requests consumes less bandwidth of the wireless medium than would identifying nearby APs using regular probe requests.

For the example of FIG. 7, the SSID of AP 300 matches one of the SSIDs stored in the STA 200 (e.g., which may indicate that the STA 200 was previously associated with the AP 300), and thus the STA 200 transmits the regular probe request to the AP 300. The AP 300 receives the regular probe request (714). The AP 300 may select a size of a regular probe response, and then transmit the regular probe response to the STA 200 (715). For some embodiments, the AP 300 may automatically mirror the received regular probe request when forming the regular probe response. The STA 200 receives the regular probe response, and thereafter associates with the AP 300 (716). Conversely, if there is not a match, as tested at 710 (or if the user does not select one of the listed SSIDs), then the STA 200 may not transmit a regular probe request to the AP 300 (718).

FIG. 8 shows a flow chart depicting an example scanning operation 800 that may be performed by one or more STAs 200 in accordance with the example embodiments. First, the STA 200 broadcasts a basic probe request having a frame body consisting of three or less information elements (802). Then, the STA 200 receives, from each of a number of APs, a basic probe response including at least the SSID of the corresponding AP (804).

Then, the STA 200 may selectively initiate a regular probing operation with a selected subset of the number of APs based, at least part, on the received SSIDs (806). For some embodiments, the STA 200 may compare the received SSIDs with a number of SSIDs stored in the STA (806A), and may then define the selected subset of APs to include only the APs whose SSID matches one of the stored SSIDs (806B). For at least one embodiment, the selected subset of APs includes only APs with which the STA has been previously associated (e.g., an AP at the user's home or office, an AP at a favorite café or other location, and so on). The STA 200 may then transmit a regular probe request only to the selected subset of APs (806C).

The STA 200 may receive a regular probe response from one or more of the APs included within the defined subset of APs (808). Thereafter, the STA 200 may initiate an association operation with a selected one of the APs based, at least in part, on the received regular probe response (810).

As described above, the example embodiments may reduce traffic on the shared wireless medium by dividing a conventional exchange of a probe request and a probe response into a two-step operation for which the exchanged frames in the first step contain less information (and thus occupy the shared wireless medium for less time) than conventional exchanges of probe requests and probe responses.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of scanning for access points (APs) within wireless range of a station (STA), the method performed by the STA and comprising:
broadcasting a basic probe request having a frame body consisting of three or less information elements;
receiving, from each of a number of APs, a basic probe response including a service set identification (SSID) of the corresponding AP; and
selectively initiating a regular probing operation with a subset of the number of APs based, at least part, on the received SSIDs.

2. The method of claim 1, wherein the subset of the number of APs includes only APs with which the STA has been previously associated.

3. The method of claim 1, wherein the frame body of the basic probe request consists of:
an SSID information element to store an SSID;
a supported rates information element to store supported data rate information; and
a direct spread spectrum sequence (DSSS) information element to store a DSSS parameter set.

4. The method of claim 3, wherein the supported rates information element includes at least one non-standard encoded value that indicates a capability of the STA.

5. The method of claim 1, wherein the selectively initiating comprises:
comparing the received SSIDs with a number of SSIDs stored in the STA;
defining the subset of APs to include only the APs whose SSID matches one of the stored SSIDs; and
transmitting a regular probe request only to the defined subset of APs.

6. The method of claim 5, wherein a frame body of the regular probe request comprises more than three information elements, and is compliant with at least the IEEE 802.11n standards and the IEEE 802.11ac standards.

7. The method of claim 1, wherein the selectively initiating comprises:
for each of the basic probe responses,
comparing the SSID of the corresponding AP with a number of SSIDs stored in the STA; and
transmitting a regular probe request to the corresponding AP only if the comparing results in a match.

8. The method of claim 7, further comprising:
receiving a regular probe response from the corresponding AP; and
initiating an association operation with the corresponding AP based, at least in part, on the received regular probe response.

9. A mobile station (STA) configured to scan for nearby access points (APs), the STA comprising:
a transceiver to exchange wireless signals with one or more APs;
one or more processor; and
a memory storing instructions that, when executed by the one or more processors, cause the STA to:
broadcast a basic probe request having a frame body consisting of three or less information elements;
receive, from each of a number of APs, a basic probe response including a service set identification (SSID) value of the corresponding AP; and
selectively initiate a regular probing operation with a subset of the number of APs based, at least part, on the received SSID values.

10. The mobile station of claim 9, wherein the subset of the number of APs includes only APs with which the STA has been previously associated.

11. The mobile station of claim 9, wherein the frame body of the basic probe request consists of:
an SSID information element to store an SSID;
a supported rates information element to store supported data rate information; and
a direct spread spectrum sequence (DSSS) information element to store a DSSS parameter set.

12. The mobile station of claim 11, wherein the supported rates information element includes at least one non-standard encoded value that indicates a capability of the STA.

13. The mobile station of claim 9, wherein execution of the instructions to selectively initiate causes the STA to:
comparing the received SSIDs with a number of SSIDs stored in the STA;
defining the subset of APs to include only the APs whose SSID matches one of the stored SSIDs; and
transmitting a regular probe request only to the defined subset of APs.

14. The mobile station of claim 13, wherein a frame body of the regular probe request comprises more than three information elements, and is compliant with at least the IEEE 802.11n standards and the IEEE 802.11ac standards.

15. The mobile station of claim 9, wherein execution of the instructions to selectively initiate causes the STA to:
for each of the basic probe responses,
compare the SSID of the corresponding AP with a number of SSIDs stored in the STA; and
transmit a regular probe request to the corresponding AP only if the compare results in a match.

16. The mobile station of claim 15, wherein execution of the instructions causes the STA to further:
receive a regular probe response from the corresponding AP; and
initiate an association operation with the corresponding AP based, at least in part, on the received regular probe response.

17. A non-transitory computer-readable medium storing instructions that, when executed by one or more processors of a mobile station (STA), cause the STA to scan for nearby access points (APs) by performing operations comprising:
broadcasting a basic probe request having a frame body consisting of three or less information elements;
receiving, from each of a number of APs, a basic probe response including a service set identification (SSID) value of the corresponding AP; and
selectively initiating a regular probing operation with a subset of the number of APs based, at least part, on the received SSID values.

18. The non-transitory computer-readable medium of claim 17, wherein the subset of the number of APs includes only APs with which the STA has been previously associated.

19. The non-transitory computer-readable medium of claim 17, wherein the frame body of the basic probe request consists of:
an SSID information element to store an SSID;
a supported rates information element to store supported data rate information; and
a direct spread spectrum sequence (DSSS) information element to store a DSSS parameter set.

20. The non-transitory computer-readable medium of claim 19, wherein the supported rates information element includes at least one non-standard encoded value that indicates a capability of the STA.

21. The non-transitory computer-readable medium of claim 17, wherein execution of the instructions for selectively initiating causes the STA to perform operations further comprising:
comparing the received SSIDs with a number of SSIDs stored in the STA;
defining the subset of APs to include only the APs whose SSID matches one of the stored SSIDs; and
transmitting a regular probe request only to the defined subset of APs.

22. The non-transitory computer-readable medium of claim 21, wherein a frame body of the regular probe request comprises more than three information elements, and is compliant with at least the IEEE 802.11n standards and the IEEE 802.11ac standards.

23. The non-transitory computer-readable medium of claim 17, wherein execution of the instructions for selectively initiating causes the STA to perform operations further comprising:
for each of the basic probe responses,
comparing the SSID of the corresponding AP with a number of SSIDs stored in the STA; and
transmitting a regular probe request to the corresponding AP only if the comparing results in a match.

24. The non-transitory computer-readable medium of claim 23, wherein execution of the instructions causes the STA to perform operations further comprising:
receiving a regular probe response from the corresponding AP; and
initiating an association operation with the corresponding AP based, at least in part, on the received regular probe response.

25. A mobile station (STA) configured to scan for nearby access points (APs), the STA comprising:
means for broadcasting a basic probe request having a frame body consisting of three or less information elements;
means for receiving, from each of a number of APs, a basic probe response including a service set identification (SSID) value of the corresponding AP; and
means for selectively initiating a regular probing operation with a subset of the number of APs based, at least part, on the received SSID values.

26. The mobile station of claim 25, wherein the subset of the number of APs includes only APs with which the STA has been previously associated.

27. The mobile station of claim 25, wherein the frame body of the basic probe request consists of:
an SSID information element to store an SSID;
a supported rates information element to store supported data rate information; and
a direct spread spectrum sequence (DSSS) information element to store a DSSS parameter set.

28. The mobile station of claim 27, wherein the supported rates information element includes at least one non-standard encoded value that indicates a capability of the STA.

29. The mobile station of claim 25, wherein the selectively initiating comprises:
means for comparing the received SSID values with a number of SSID values stored in the STA;
means for defining the subset of APs to include only the APs whose SSID value matches one of the stored SSID values; and
means for transmitting a regular probe request only to the defined subset of APs.

30. The mobile station of claim 29, wherein a frame body of the regular probe request comprises more than three information elements, and is compliant with at least the IEEE 802.11n standards and the IEEE 802.11ac standards.
